(19) United States
(12) Patent Application Publication
(10) Pub. No.: US 2010/0184412 A1
(43) Pub. Date: Jul. 22, 2010

(54) METHOD AND SYSTEM FOR INTERNET COMMUNICATION BY MOBILE PHONE

(75) Inventors: YONG-HUI XIAO, Shenzhen City (CN); LI-RONG ZHANG, Shenzhen City (CN); YI-FANG WU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRESICION INDUSTRY CO., LTD., Tu-Cheng (TW)

(21) Appl. No.: 12/464,549

(22) Filed: May 12, 2009

(30) Foreign Application Priority Data
Jan. 16, 2009 (CN) 200910300228.1

(51) Int. Cl. H04M 3/42; H04W 88/16

(52) U.S. Cl. 455/414.1; 455/466

(57) ABSTRACT

A system for Internet communication by mobile phone includes a server and a gateway. The gateway is connected to a mobile phone via a wireless network, and connected to the server via Internet. The gateway allows login to the server according to access authorization information transmitted by the mobile phone, and transmits messages from the mobile phone to Internet users displayed on the mobile phone via the server when the user successfully logs onto the server. The gateway receives messages from Internet users via the server, and transmits messages from Internet users to the mobile phone.

### BACKGROUND

1. Technical Field

The present disclosure relates to wireless communication, and particularly to a method and system for Internet communication by mobile phone.

2. Description of Related Art

Mobile devices provide various communication applications for different users. Currently, users may access the Internet through personal mobile devices such as Personal Digital Assistants (“PDA”), mobile phones, and others. Alerts and predetermined notifications related to such as stock movement and other events are examples of information received. The type and amount of information received may, however, be restricted by hardware and physical network limitations. When a mobile phone is used to access the Internet to receive Instant Messaging (IM) information, for example, the mobile phone must be connected to the Internet via GPRS or other wireless network. The requisite IM software must have been previously installed therein for such communication, a memory and time-consuming requirement. Further, certain mobile phones do not support GPRS or 3G network connectivity, and thus cannot connect to the Internet.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a system for Internet communication by mobile phone.

FIG. 2 is a flowchart of a method of Internet communication by mobile phone using a system such as that shown in FIG. 1.

### DETAILED DESCRIPTION

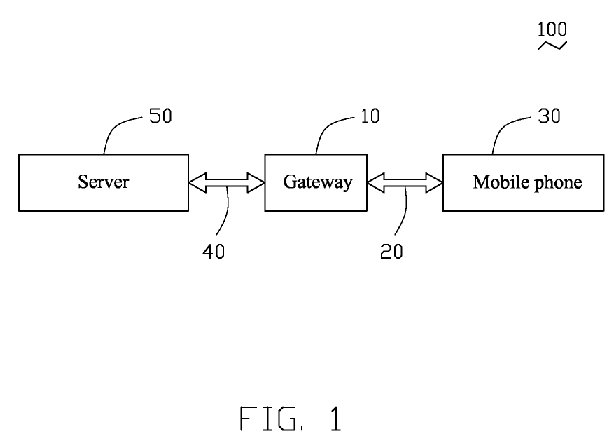

Referring to FIG. 1, a system 100 for Internet communication by mobile phone includes a gateway 10, at least one mobile phone 30, and a server 50. The gateway 10 connects to the server 50 via the Internet 40. The mobile phone 30 is connected to the gateway 10 via a wireless network 20. The wireless network 20 can be a GSM network, CDMA network, or other. The server 50 carries at least one Instant Messaging (IM) software application such as ICQ, MSN, QQ, or others.

A plurality of user accounts is registered in the gateway 10. Every user account includes information for the user, such as contact, account, and other information. Access authorization information is submitted to the server 50 via the gateway 10, which, upon authentication, logs the user onto the server 50.

Access authorization information can include account information, user name, and password. For convenient processing of the submitted access authorization information can comply with a format, such as “account: xxxx; user name: xxxx; password: xxxx”. (where “xxxx” represents different access authorization information content.)

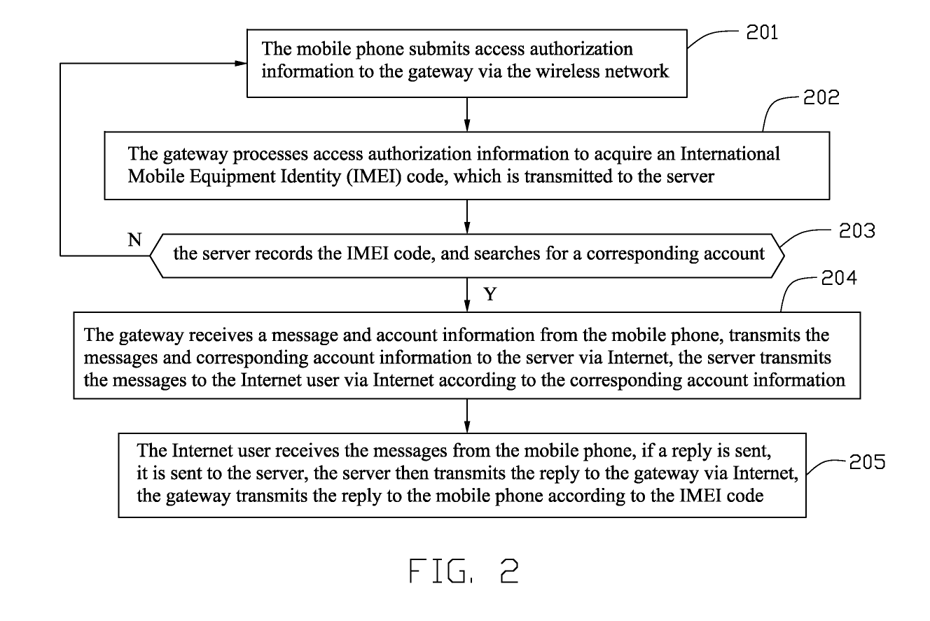

Referring to FIG. 2, when the mobile phone 30 submits access authorization information in the format disclosed, access authorization information is processed as follows.

In Step 201, the mobile phone 30 submits access authorization information to the gateway 10 via the wireless network 20.

In Step 202, the gateway 10 processes access authorization information to acquire an International Mobile Equipment Identity (IMEI) code, which is transmitted to the server 50.

In Step 203: the server 50 records the IMEI code, and searches for a corresponding account. If none is found, the login fails, and the server 50 requests re-entry of the access authorization information, and Step 201 is repeated. If a corresponding account is located, login is successful and server 50 transmits the user status to the mobile phone 30 via the gateway 10.
In Step 204: the gateway 10 receives a message and account information from the mobile phone 30, the account information corresponding to an Internet user displayed on the mobile phone 30, transmits the messages and corresponding account information to the server 50 via Internet 40. The server 50 transmits the messages to the Internet user via Internet 40 according to the corresponding account information.
In Step 205: the Internet user receives the messages from the mobile phone 30. If a reply is sent, it is sent to the server 50. The server 50 then transmits the reply to the gateway 10 via Internet 40, and the gateway 10 transmits the reply to the mobile phone 30 according to the IMEI code.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method communication by mobile phone, the method comprising:
storing access authorization information on a mobile phone;
transmitting the access authorization information to a gateway connected to the mobile phone via a wireless network;
processing the access authorization information by the gateway, and communicating the access authorization information to a server having at least one instant messaging application;
searching for an account on the server corresponding to the access authorization information;
if no account corresponding to the access authorization information is located, canceling the login and requesting a repeat input of access authorization information;
if an account corresponding to the access authorization information is located, accepting the login and transmitting information concerning Internet users to the mobile phone via the gateway;
sending messages from the mobile phone and account information of the corresponding Internet user to the server from the gateway, the server then transmits the messages to the Internet user via Internet according to the account information.

2. The method of claim 1, further comprising the gateway processing access authorization information to acquire an International Mobile Equipment Identity (IMEI) code of the mobile phone before access authorization information is transmitted to the server, and transmitting the IMEI code to the server.

3. The method of claim 2, further comprising the Internet user replying to the server after receiving the messages from the mobile phone, the server transmitting the reply to the gateway via Internet, the gateway transmitting the reply to the mobile phone according to the IMEI code.

4. The method of claim 1, wherein access authorization information comprises account information, user name, and password.

5. The method of claim 1, wherein the server is connected to the gateway via Internet.

6. A system for Internet communication by mobile phone, comprising:
a server having at least one instant messaging application;
a gateway connected to the mobile phone via a wireless network, and connected to the server via Internet; wherein the gateway is capable of receiving a login request from a mobile phone logged onto the server according to access authorization information transmitted by the mobile phone, transmitting messages from the mobile phone to Internet users displayed on the mobile phone via the server when the login is successful, receiving messages from Internet users via the server, and transmitting messages from Internet users to the mobile phone.

7. The system of claim 6, wherein the gateway is a Short Messaging Service (SMS) server.

8. The system of claim 6, wherein the wireless network is a GSM network or a CDMA network.

9. The system of claim 6, wherein access authorization information comprises account information, user name, and password.
